(19) United States
(12) Patent Application Publication
(10) Pub. No.: US 2021/0390256 A1
(43) Pub. Date: Dec. 16, 2021

(54) METHODS AND SYSTEMS FOR MULTIPLE ENTITY TYPE ENTITY RECOGNITION

(71) Applicant: INTERNATIONAL BUSINESS MACHINES CORPORATION, Armonk, NY (US)

(72) Inventors: Haibin LIU, San Jose, CA (US); Anbang XU, San Jose, CA (US); Rama Kalyani T. AKKIRAJU, Cupertino, CA (US)

(73) Assignee: INTERNATIONAL BUSINESS MACHINES CORPORATION, Armonk, NY (US)

(21) Appl. No.: 16/946,287

(22) Filed: Jun. 15, 2020

(51) Int. Cl. G06F 40/295; G06K 9/62

(52) U.S. Cl. CPC G06F 40/295; G06K 9/6227

(57) ABSTRACT

Embodiments for generating entity recognition models are provided. A data set including a plurality of entity references and a plurality of entity types are received. The plurality of entity types are divided into a plurality of entity type groups. The data set is divided into a plurality of data subsets. Each of the plurality of data subsets is associated with a respective one of the plurality of entity type groups. A plurality of entity recognition models are trained. Each of the plurality of entity recognition models is trained based on a respective one of the plurality of entity type groups and a respective one of the plurality of data subsets. A combined entity recognition model is generated based on the plurality of entity recognition models.

### BACKGROUND OF THE INVENTION

### Field of the Invention

The present invention relates in general to computing systems, and more particularly, to various embodiments for entity recognition, such as named-entity recognition (NER).

### Description of the Related Art

Computing systems (and/or search algorithms) are often used to search various corpora (one or more corpus), such as unstructured documents, text-based documents, spreadsheets, etc., for information related to entities (e.g., individuals/people, organizations, objects, places, events, etc.). This process is sometimes referred to as “knowledge discovery.” The identification or extraction of entities (and/or references to or mentions of entities) from the corpus (e.g., named-entity recognition (NER)) is an important step in this process, as well as other methods, such as natural language processing (NLP), natural language understanding (NLU), etc.

NER often involves locating (or identifying, extracting, etc.) references to entities and classifying the entities into (e.g., predefined) categories, such as individuals (e.g., people), organizations, locations, time expressions, quantities, monetary values, etc. In many instances (e.g., within particular domains or subjects), customized NER models are required to adequately recognize entities, as entities (and/or the recognition thereof) may vary significantly in different domains or environments.

Although some services to perform this task are publicly available, such typically only provide entity recognition for a very limited number of entity types. As a result, in some instances, customized NER models may need to be generated and trained, which may be expensive and time-consuming.

### SUMMARY OF THE INVENTION

Various embodiments for generating entity recognition models, by a processor, are provided. A data set including a plurality of entity references and a plurality of entity types are received. The plurality of entity types are divided into a plurality of entity type groups. The data set is divided into a plurality of data subsets. Each of the plurality of data subsets is associated with a respective one of the plurality of entity type groups. A plurality of entity recognition models are trained. Each of the plurality of entity recognition models is trained based on a respective one of the plurality of entity type groups and a respective one of the plurality of data subsets. A combined entity recognition model is generated based on the plurality of entity recognition models.

In addition to the foregoing exemplary embodiment, various other system and computer program product embodiments are provided and supply related advantages. The foregoing Summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block diagram a system for generating entity recognition models according to an embodiment of the present invention;

FIG. 5 is a block diagram a system for generating entity recognition models according to an embodiment of the present invention;

FIG. 6 is a block diagram a system for generating entity recognition models according to an embodiment of the present invention; and

FIG. 7 is a flowchart diagram of an exemplary method for generating an entity recognition model according to an embodiment of the present invention.

### DETAILED DESCRIPTION OF THE DRAWINGS

As discussed above, computing systems (and/or search algorithms) are often used to search various corpora (one or more corpus), such as unstructured documents, text-based documents, spreadsheets, etc., for information related to entities (e.g., individuals/people, organizations, objects, places, events, etc.). This process is sometimes referred to as “knowledge discovery.” The identification or extraction of entities (and/or references to or mentions of entities) from the corpus (e.g., named-entity recognition (NER)) is an important step in this process, as well as other methods, such as natural language processing (NLP), natural language understanding (NLU), etc.

NER often involves locating (or identifying, extracting, etc.) references to entities and classifying the entities into (e.g., predefined) categories, such as individuals (e.g., people), organizations, locations, time expressions, quantities, monetary values, etc. In many instances (e.g., within particular domains or subjects), customized NER models are required to adequately recognize entities, as entities (and/or the recognition thereof) may vary significantly in different domains or environments.

Although some services to perform this task are publicly available, such typically only provide entity recognition for a very limited number of entity types. As a result, in some instances, customized NER models may need to be generated and trained, which may be expensive and time-consuming.

Generally, current solutions for NER utilize a uniform model for the recognition of all entity types or utilize at most two NER models. For example, one model may be a “rule-based” model, and the other model may be based on (and/or generated utilizing) machine learning techniques. Little effort has been applied to attempt to accommodate the recognition of many entity types.

Current uniform model solutions may be less than ideal because, for example, existing data have missing entity types, leading to false negative samples. Downsampling or discarding incomplete data may alleviate such problems, but it leads to wasted data. Additionally, although it may be possible to train a separate model for each entity type, this may lead to missing co-occurrence information.

To address these needs and/or the shortcomings in the prior art, in some embodiments described herein, methods and/or systems are disclosed that, for example, facilitate the training and/or creation of customized entity recognition (e.g., NER) models for multiple entity types. In some embodiments, the methods and systems utilize a workflow that includes dividing the entity types into groups (or sub-groups), training an entity recognition model for each group, and merging the models in a combined (or composite) model, which may then be utilized for entity recognition for multiple entity types.

In some embodiments, the methods and/or systems described herein include, for example, receiving data (e.g., entity types and annotated data provided by a user), analyzing the data (e.g., determining correlations between entity types), dividing (or “slicing”) the data (and/or entity types) into groups, training a model for each of the groups, and combining the different models into a single model.

More particularly, in some embodiments, the system may receive (or detect) an entity type system and annotated data. The entity type system may include a list or collection of all entity types that a user desires to utilize. The annotated data may include text or corpus (including alphanumeric characters) with various words that have been “tagged” or labeled with the entity types from the entity type system. Examples of texts/corpora include, but are not limited to, one or more of any type of suitable document, file, database, etc., such as unstructured documents, websites, word processing documents, spreadsheets, electronic communications (e.g., emails, text messages, etc.), audio/video files, etc.

The entity type system and the annotated data may be provided to a data analyzer that, for example, determines correlations between entities (and/or entity types). Correlations between entity types may be determined based on, for example, repeated references to such entities within a predetermined distance or “window” (e.g., “text distance”). For example, entity references that occur within the same sentence (or paragraph), within the phrase (or sentence, clause, etc.), and/or are determined to be the closest (or immediate) instance of a noun or noun phrase of each other may be indicative of a correlation (e.g., at least if such occurs repeatedly). As one specific example, references to organizations that commonly appear near individuals' names (e.g., the individual's employer) may cause a correlation between such entity types to be determined.

The data and/or entity types may be divided into multiple groups (or sub-groups, subsets, etc.) based on the correlations, user preferences, one or more threshold, a model, etc. An entity recognition (e.g., NER) model may then be trained based on each of the groups (e.g., to generate multiple models). The models may then be combined or merged to generate a combined or composite model.

In some embodiments, a confidence value (or score) is determined (or calculated) and utilized to determine a correlation (or lack thereof) between entity types (e.g., between two entity types). For example, the confidence score, as a correlation between two entity types (X and Y) may be expressed as

conf(X∩Y)=supp(X∩Y)/supp(X∩Y) (1)

where

supp(X)=|{s∈D, where s contains entity type X}|/|D| (2)

supp(X∩Y)=|{s∈D, where s contains entity type X and Y}|/|D| (3)

supp(X∩Y)=|{s∈D, where s contains entity type X or Y}|/|D| (4)

A graph (e.g., an ontology graph, knowledge graph, etc.) may be composed with the nodes being representative of entity types (e.g., each node representing a particular entity type) and the edges (or “lines”) between the nodes being representative of correlations between entity types. The determined confidence values may be assigned to the edges as weights. The groupings of the entity types (and/or entities) may then be considered as a graph partition (or partitioning) problem. Embodiments described herein may utilize various methods (i.e., individually or in combination) for partitioning the graph (and/or dividing the entity types into groups).

For example, a “brute force” method may be utilized. Using such, each possible combination of entity types may be enumerated, and a model may then be trained for each combination. The models with the best performance may then be selected. This may include training a model for each of the entity types. In such a scenario, the user may select any two (or more) of the entity types, choose training data that contains only those types of entities, and then train NER models. For each entity type, the model with the best performance may be selected. In some embodiments, the selected models to not “overlap” (i.e., each relevant entity type is only covered by one model) and cover all (relevant) entity types.

Another example is the use of a confidence value threshold (or thresholds). That is, entities may be grouped together if their correlation value exceeds a predetermined threshold. Additionally, a graph partitioning algorithm, such as a spectral partitioning algorithm, may be utilized.

In some embodiments, a correlation analysis is performed (e.g., on the training data) before (and/or after) the grouping of the entity types. That is, entity types that frequently appear together probably influence each other significantly. For example, a “sporting event” entity will often appear with a “location” entity and “date/time” entity. Such may be utilized to form the groups (or sub-groups) of entity types.

It should be understood that the methods and systems described herein may be used in combination (i.e., a “hybrid” strategy/method) with convention entity recognition methods/models, such as ruled based models. For example, if a user determines that a particular rule based model is sufficiently effective for particular entities/entity types, rule based models may be utilized for those entities, while the methods and systems described herein are utilized for other entities. Additionally, embodiments described herein may utilize any suitable solution to account for typographical and spelling errors in (and/or alternative spellings of) entity names, such as string metrics and string matching, as is commonly understood. Further, embodiments described herein may utilize any suitable solution to account for the usage of pronouns (e.g., he, she, they, it, etc.) in place of more complete versions of the entity names.

In some embodiments, at least some of the functionality described herein (e.g., generating models) is performed utilizing a cognitive analysis. The cognitive analysis may include classifying natural language, analyzing tone, and analyzing sentiment (e.g., scanning for keywords, key phrases, etc.) with respect to, for example, content and communications sent to and/or received by users, and/or other available data sources. In some embodiments, natural language processing (NLP) and/or natural language understanding (NLU), Mel-frequency cepstral coefficients (MFCCs) (e.g., for audio content), and/or region-based convolutional neural network (R-CNN) pixel mapping (e.g., for images/videos), as are commonly understood, are used. As such, it should be understood that the methods/systems described herein may be applied to content other than text-based (or alphanumeric) content but also audio content and/or images/videos (e.g., an event associated with an entity is referenced in an audio and/or video file).

The processes described herein may utilize various information or data sources associated with users (e.g., users who provide search queries and/or entities) and/or the content (e.g., the document(s), file(s), etc. within the corpus). With respect to users, the data sources may include, for example, any available data sources associated with the user. For example, in some embodiments, a profile (e.g., a cognitive profile) for the user(s) may be generated. Data sources that may be use used to generate a cognitive profile for the user(s) may include any appropriate data sources associated with the user that are accessible by the system (perhaps with the permission or authorization of the user). Examples of such data sources include, but are not limited to, communication sessions and/or the content (or communications) thereof (e.g., phone calls, video calls, text messaging, emails, in person/face-to-face conversations, etc.), a profile of (or basic information about) the user (e.g., job title, place of work, length of time at current position, family role, etc.), a schedule or calendar (i.e., the items listed thereon, time frames, etc.), projects (e.g., past, current, or future work-related projects), location (e.g., previous and/or current location and/or location relative to other users), social media activity (e.g., posts, reactions, comments, groups, etc.), browsing history (e.g., web pages visited), and online purchases.

As such, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, the generating entity recognition models, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

It should be understood that the embodiments described herein may be applied to any type of entity, such as individuals (and/or given/family names, nicknames, alternative names, aliases, etc. thereof), as well as the names (or other descriptive terms) of any type of entity, such as organizations, objects, places, events, etc.

It should also be understood that as used herein, the term “computing node” (or simply “node”) may refer to a computing device, such as a mobile electronic device or a desktop computer, and/or an application, such a chatbot, an email application, a social media application, a web browser, etc. In other words, as used herein, examples of computing nodes include, for example, computing devices such as mobile phones, tablet devices, desktop computers, or other devices, such as appliances (IoT appliances) that are owned and/or otherwise associated with individuals (or users), and/or various applications that are utilized by the individuals on such computing devices.

In particular, in some embodiments, a method for generating an entity recognition model, by a processor, is provided. A data set including a plurality of entity references and a plurality of entity types are received. The plurality of entity types are divided into a plurality of entity type groups. The data set is divided into a plurality of data subsets. Each of the plurality of data subsets is associated with a respective one of the plurality of entity type groups. A plurality of entity recognition models are trained. Each of the plurality of entity recognition models is trained based on a respective one of the plurality of entity type groups and a respective one of the plurality of data subsets. A combined entity recognition model is generated based on the plurality of entity recognition models.

Correlations between at least some of the plurality of entity types may be determined based on the data set. The dividing of the plurality of entity types into the plurality of entity type groups may be based on calculated scores associated with the determined correlations. The dividing of the plurality of entity types into the plurality of entity type groups may be based on a graph partitioning algorithm applied to a graph composed based on the determined correlations.

The combined entity recognition model may be generated based on only selected ones of the plurality of entity recognition models. Each of the plurality of entity types may be covered by only one of the selected ones of the plurality of entity recognition models. The plurality of entity references in the data set are tagged with entity types.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

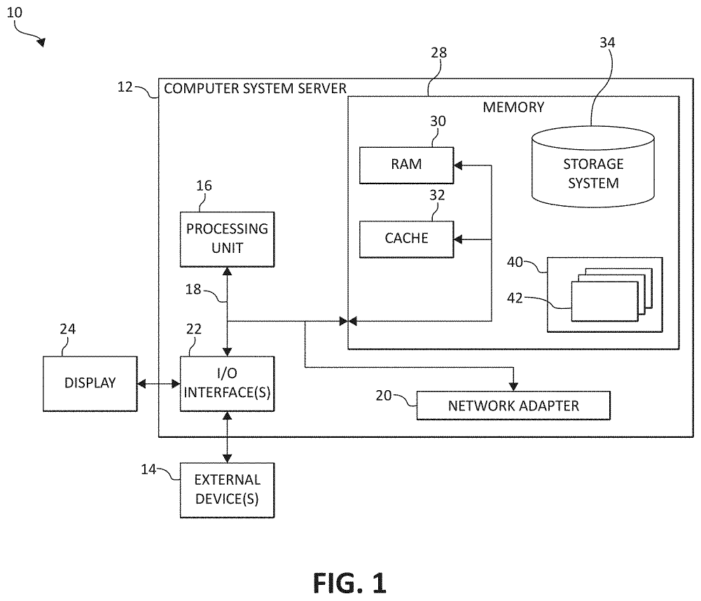

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. However, in some embodiments, some of the components depicted in FIG. 1 may be located in a computing device in, for example, a satellite, such as a Global Position System (GPS) satellite. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

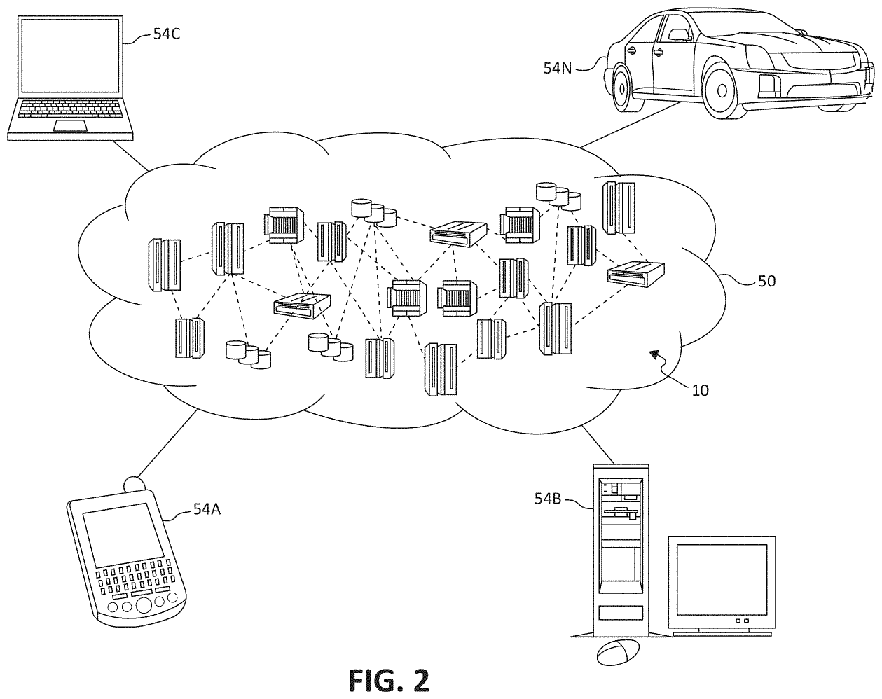

Referring now to FIG. 2, illustrative cloud computing environment 50 is depicted. As shown, cloud computing environment 50 comprises one or more cloud computing nodes 10 with which local computing devices used by cloud consumers, such as, for example, cellular (or mobile) telephone or PDA 54A, desktop computer 54B, laptop computer 54C, and vehicular computing system (e.g., integrated within automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

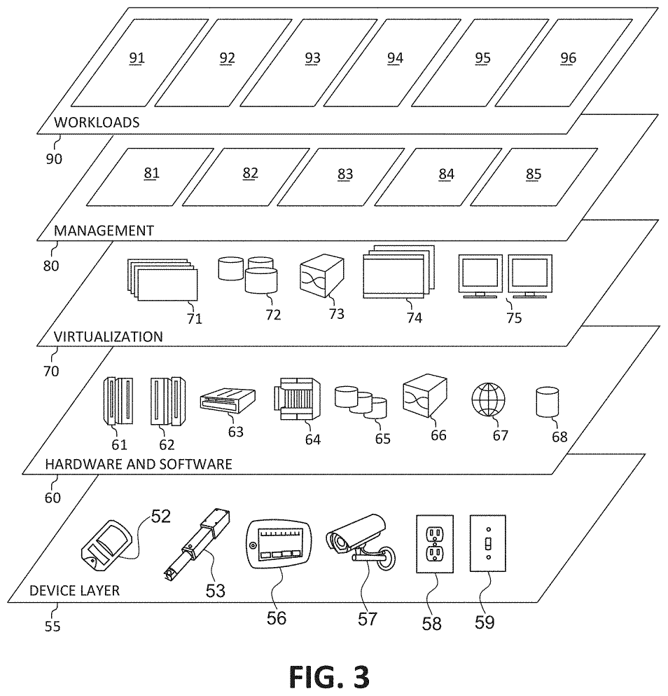

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator, washer/dryer, or air conditioning unit, and a wide variety of other possible interconnected devices/objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for generating entity recognition models, as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, in some embodiments, methods and/or systems for generating entity recognition (e.g., NER) models are provided. In some embodiments, a data set including a plurality of entity references and a plurality of entity types are received. The plurality of entity types are divided into a plurality of entity type groups. The data set is divided into a plurality of data subsets. Each of the plurality of data subsets is associated with a respective one of the plurality of entity type groups. A plurality of entity recognition (e.g., NER) models are trained. Each of the plurality of entity recognition models is trained based on a respective one of the plurality of entity type groups and a respective one of the plurality of data subsets. A combined entity recognition model is generated based on the plurality of entity recognition models.

In some embodiments, correlations between at least some of the plurality of entity types are determined based on the data set. The correlations may be utilized in the dividing of the plurality of entity types into the plurality of entity type groups. For example, scores (or grades, etc.) may be calculated (or determined) for the correlations, which are then used form the groups of entity types. In some embodiments, the dividing of the plurality of entity types into the plurality of entity type groups is based on a graph partitioning algorithm applied to a graph composed based on the correlations.

The combined entity recognition model may be generated based on only selected ones of the plurality of entity recognition models. Each of the plurality of entity types may be covered by only one of the selected ones of the plurality of entity recognition models. The plurality of entity references in the data set are tagged with entity types.

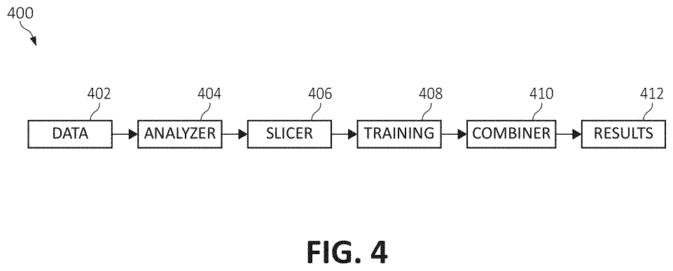

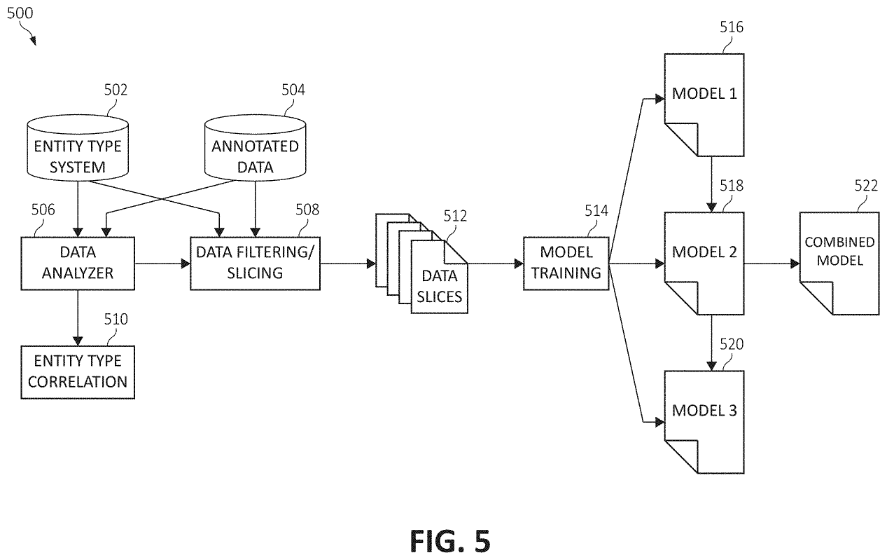

FIG. 4 illustrates a simplified system and/or method (or workflow) 400 for generating entity recognition models according to some embodiments described herein. Each of the components (and/or steps/processes) shown in FIG. 4, as well as those shown in FIGS. 5-7, may be implemented utilizing any suitable computing device, such as those described above (e.g., a desktop PC, a mobile electronic device, etc.), which may be integrated into common computing devices and/or located locally. However, in some embodiments, the components may be remote from each other and in operable communication via any suitable communication network (e.g., the Internet).

Still referring to FIG. 4, the system 400 receives (or is provided with) data 402. The data 402 may include annotated data and an entity type system, as described above. The data 402 is processed by an analyzer 404 that, for example, determines correlations between entity types based on the annotated data. The output of the analyzer 404 is provided to a “slicer” 406, which, for example, divides the annotated data into data subsets (or “slices”) and divides the entity types into groups. The dividing of the data and/or the entity types may be based on correlations and/or scores calculated by the analyzer 404 (and/or the slicer 406). A training module 408 receives the output of the slicer 406 and trains (and/or generates) a NER model for each of the data subsets and entity groups (e.g., for each data subset and entity group pair). A combiner 410 merges the individual NER models into a “combined” or “composite” model, the result(s) 412 of the system 400. The combined model 412 may then be utilized to perform NER on any suitable corpus.

FIG. 5 is a more detailed block diagram of a system (and/or method) 500 for generating entity recognition models according to some embodiments. The system 500 receives an entity type system 502 and annotated data 504, as described above, which are provided to a data analyzer 506 and a data filtering (and/or slicing) module 508. The data analyzer 506 determines entity type correlations 510, which are provided to the data filtering module 508, which utilizes such to divide the annotated data into slices 512 (and divide the entity types into groups). This process may be performed in several ways, as described below. A model training module 514 trains (and/or generates) an entity recognition model for each of the data slices (or subsets) 512 (i.e., for each data slice/entity type groups pair). The example shown includes three models 516, 518, and 520. However, in other embodiments, different numbers of models may be trained. As described above, the models 516-520 are merged (or combined) into a combined model 522.

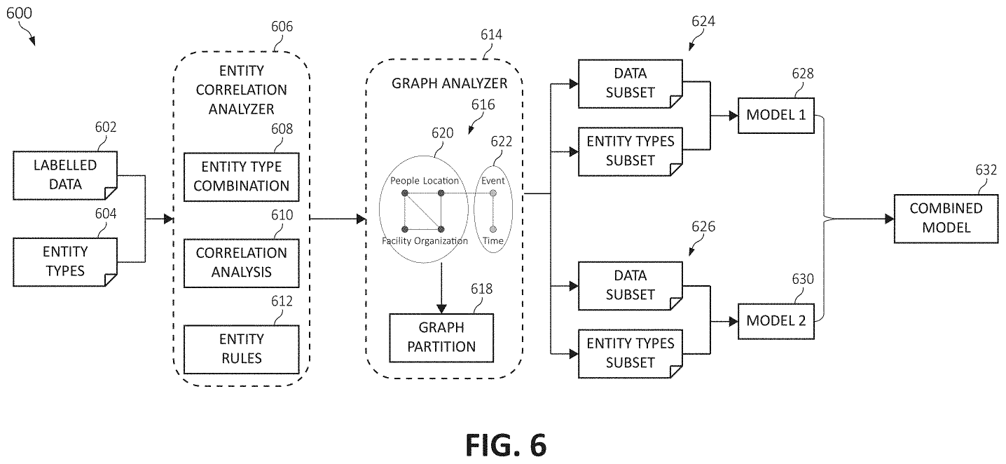

Referring now to FIG. 6, a block diagram of a system (and/or method) 600 for generating entity recognition models is shown. Similar to the embodiments described above, the system 600 receives labeled data (or annotated data) 602 and entity types (or an entity type system) 604, which are received by an entity correlation (or data) analyzer 606. In the depicted embodiment, the entity correlation analyzer 606 includes (and/or utilizes) entity type combinations (or an entity type combination module) 608, a correlation analysis module 610, and entity rules 612. The entity type combinations 608 may include the various combinations of entities and/or entity types detected in the labeled data 602. The correlation analysis module 610 may determine correlations between the entities/entity types and/or determine the strength of such correlations (e.g., score the correlations). The entity rules 612 may include (e.g., user defined) constraints on the utilized entities/entity types, the combinations/correlations thereof, etc.

In some embodiments, the dividing of the data and the entity groups may be considered to be performed utilizing a graph (e.g., a knowledge graph) and a graph partitioning method. For example, in the example shown in FIG. 6, the output of the entity correlation analyzer 606 is provided to a graph analyzer 614. The graph analyzer 614 generates a graph 616 based on the correlation data received from the entity correlation analyzer 606. The graph 616 may include nodes that represent entity types and edges that interconnect the nodes that represent correlations between the entity types. The graph analyzer 614 utilizes (and/or includes) a graph partition (or partitioning) module 618, that divides the graph into groups.

In the (exemplary, perhaps partial) graph 616 shown in FIG. 6, the graph 616 has been divided into a first group (or partition) 620 and a second group 622. The first group 620 includes the entity types “people,” “location,” “facility,” and “organization.” The second group 622 includes the entity types “event” and “time.” The graph partitioning module may utilize various methods to partition the graph 616 (and/or divide the data and entity types into slices/groups), such as correlation scores (or confidence values) and/or associated thresholds and graph partitioning algorithms.

Still referring to FIG. 6, the output of the graph analyzer 614 is utilized to generate data subset/entity type groups pairs 624 and 626, each of which corresponds to/is associated with one of the groups/partitions 620 and 622 of the graph 616. That is, each of the pairs 624 and 626 includes an entity type group (or subset) and a data subset. Although two pairs 624 and 626 are shown, in other embodiments, different numbers of pairs may be generated (i.e., depending on the number of groups of entities), which causes different numbers of entity recognition models to be trained.

In the example shown in FIG. 6, two models (i.e., entity recognition models) 628 and 630 are generated and trained. More particularly, model 628 (Model 1) is trained based on data subset/entity type group 624, and model 630 (Model 2) is trained based on data subset/entity type group 630). As such, model 628 covers the entity types in partition 620 of the graph 616, and model 630 covers the entity types in partition 622 of the graph 616. The models 628 and 630 are then merged into a combined model 632.

As described above, the entity correlation analyzer 606 receives entity types (or an entity type system) and labeled (or annotated) data as input. The entity types may be expressed as E={e₁, e₂, e₃, . . . , eₘ}. The annotated data (or data set) may be express as D={s₁, s₂, . . . , sₙ}, where sᵢ includes annotation of at least one entity type e∈E. Entity subgroups that are generated may be express as {E₁, E₂, . . . , Eₖ}, where Eⱼ⊆E, 1<=j<=k.

Several strategies may be utilized for the entity correlation analysis and/or forming groups of entities. For example, a brute force/combination trial method may be utilized. Using such, the system generates all possible combinations/groups, which may results in a model being trained for each individual entity type, for every two types, every three types, etc. In some embodiments, for each entity type, the model with the best performance is selected. For example, for entity type e₁, the groups may include E₁={e₁}, E₂={e₁, e₂}, E₃={e₁, e₃}, E₂={e₁, e₂, e₃}, etc. It should be noted that the groups (or subgroups) are not exclusive (e.g., some entity types are included in multiple groups).

With respect to the graph partition method(s), a graph may be generated such that G=(E, W, edge-weight function c), where the nodes E are entity types, edges W exist between the entity types if there is a correlation therebetween, and edge weight is determined by the correlation score (or confidence value). Edge weight score may be expressed as supp(eᵢ∩eⱼ)/supp(eᵢ∪eⱼ), where supp(eᵢ)=|{s∈D, where s contains entity type eᵢ}|/|D|, supp(eᵢ∩eⱼ)=|{s∈D, where s contains entity type eᵢ and eⱼ}|/|D|, and supp(eᵢ∪eⱼ)=|{s∈D, where s contains entity type eᵢ or eⱼ}|/|D|.

In some embodiments, after the graph is composed, an edge weight threshold (δ) may be utilized. For example, given the graph G=(E, W, edge-weight function c), all of the edges that have weights (or scores) less than the threshold are deleted. The nodes in the remaining sub-graphs or partitions (i.e., any entity types that remain connected via edges) may then be utilized as the entity types in the entity type groups. Utilizing such a method, the entity type groups are mutually exclusive (i.e., each entity type appears in only one group).

With respect to data slicing, in some embodiments, the received annotated data set is split (e.g., randomly split) into different sets (or subsets) before being sliced for the different entity type groups. For example, the received annotated data may be divided into a “train” data set, a “dev” data set,” and a “test” data set. The train data set may be sliced according to the entity type groups, as discussed above. For example, for any group Eₛ={e₁, e₂, . . . , eₖ}, a subset of the train data may be obtained by applying a filtering, D_{Es}={sᵢ, where s∈D and sᵢ contains e∈Eₛ}.

As will be appreciated by one skilled in the art, the entity recognition model(s) may be formed utilizing machine learning techniques. For example, for each entity type group Eₛ, and sliced data set D_{Es}, a machine learning technique may be applied to generate a model mₛ.

As described above, the entity recognition models trained for each entity type group/data subset are combined into a composite/combined model. That is, given models M={m₁, m₂, . . . }, where each model mⱼ is trained for an entity subgroup Eⱼ. In some scenarios, it is possible that more than one of the entity type groups includes a particular entity type and/or a particular entity type is covered by more than one model. That is, there is a set of entity groups that includes eᵢ, Sᵢ={Eᵢⱼ∈E and eᵢ∈Eᵢⱼ} and a set of model for those entity type groups, Mₛᵢ={mᵢⱼ, where Eᵢⱼ∈Sᵢ}. Each model mᵢⱼ may be applied to the dev data set, and the model with the best performance (i.e., with respect to eᵢ) may be marked or tagged m_{ijb} as such. Model m_{ijb} may then be included with the final, combined model M_{C}=M_{C}∪{m_{ijb}}. As such, the combined model set M_{C} includes a best performance model for each entity type. It should be noted that one of the models may provide the best performance for multiple entity types.

As such, embodiments described herein provide systems and methods for training and/or generating customized entity recognition (e.g., NER) models for multiple entity types. As described above, in some embodiments, a user provided (annotated) data set and entity types are utilized. A data analyzer learns or determines correlations between entity types based on the provided data set. A module divides entity types into groups (or subgroups) based on the results from the analyzer. A module divides the annotated data into data subsets. A model training module trains multiple entity recognition (e.g., NER) models separately. The models are then combined and/or merged into a combined or composite model.

Thus, embodiments described herein may be considered to utilize a “divide and conquer” strategy to entity recognition problems. The systems and methods described herein may provide improved efficiency and performance compared to conventional techniques. For example, false negative data samples may be reduced, providing improved performance. Additionally, the utilization of relatively small data sets for training may increase efficiency.

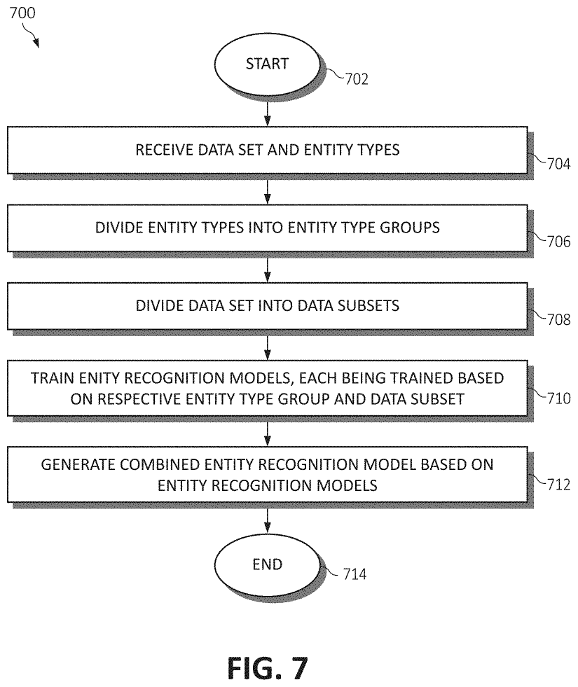

Turning to FIG. 7, a flowchart diagram of an exemplary method 700 for generating an entity recognition (e.g., NER) model (or one or more such models) is provided. The method 700 begins (step 702) with, for example, a user (e.g., an individual or automated system) selecting (or creating) an annotated data set (e.g., including text or a corpus with entities tagged with entity type labels) and a list of entity types (or entity type system).

The (annotated) data set including a plurality of entity references and a plurality of entity types are received (step 704). For example, the data set and the entity types may be provided to and/or retrieve by any suitable computing node configured to perform the functionality described herein, including any related cognitive analysis, as described above.

The plurality of entity types are divided into a plurality of entity type groups (step 706). Correlations between at least some of the plurality of entity types may be determined based on the data set. The dividing of the plurality of entity types into the plurality of entity type groups may be based on calculated scores associated with the determined correlations. The dividing of the plurality of entity types into the plurality of entity type groups may be based on a graph partitioning algorithm applied to a graph composed based on the determined correlations.

The data set is divided into a plurality of data subsets (step 708). Each of the plurality of data subsets may be associated with a respective one of the plurality of entity type groups.

A plurality of entity recognition models are trained (and/or generated) (step 710). Each of the plurality of entity recognition models may be trained based on a respective one of the plurality of entity type groups and a respective one of the plurality of data subsets. Each of the plurality of entity types may be covered by only one of the selected ones of the plurality of entity recognition models.

A combined entity recognition (e.g., NER) model is generated based on the plurality of entity recognition models (step 712). The combined entity recognition model may be generated based on only selected ones of the plurality of entity recognition models. For example, the models may be tested to determine which have the best performance with respect to the different entity types, as described above.

Method 700 ends (step 714) with, for example, the combined entity recognition model being tested and utilized to perform entity recognition with respect to at least the entity types for which the individual entity recognition models were trained. It should be understood that the combined entity recognition model may be utilized in combination with other techniques, such as ruled based models, as described above. In some embodiments, feedback from users (e.g., early adopters and/or later uses) may also be utilized to improve the performance of the system over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for generating an entity recognition model, by a processor, comprising:
receiving a data set and a plurality of entity types, wherein the data set includes a plurality of entity references;
dividing the plurality of entity types into a plurality of entity type groups;
dividing the data set into a plurality of data subsets, wherein each of the plurality of data subsets is associated with a respective one of the plurality of entity type groups;
training a plurality of entity recognition models, wherein each of the plurality of entity recognition models is trained based on a respective one of the plurality of entity type groups and a respective one of the plurality of data subsets; and
generating a combined entity recognition model based on the plurality of entity recognition models.

2. The method of claim 1, further comprising determining correlations between at least some of the plurality of entity types based on the data set.

3. The method of claim 2, wherein the dividing of the plurality of entity types into the plurality of entity type groups is based on calculated scores associated with said determined correlations.

4. The method of claim 2, wherein the dividing of the plurality of entity types into the plurality of entity type groups is based on a graph partitioning algorithm applied to a graph composed based on said determined correlations.

5. The method of claim 1, wherein the combined entity recognition model is generated based on only selected ones of the plurality of entity recognition models.

6. The method of claim 5, wherein each of the plurality of entity types is covered by only one of the selected ones of the plurality of entity recognition models.

7. The method of claim 1, wherein the plurality of entity references in the data set are tagged with entity types.

8. A system for generating an entity recognition model comprising:
a processor executing instructions stored in a memory device, wherein the processor:
receives a data set and a plurality of entity types, wherein the data set includes a plurality of entity references;
divides the plurality of entity types into a plurality of entity type groups;
divides the data set into a plurality of data subsets, wherein each of the plurality of data subsets is associated with a respective one of the plurality of entity type groups;
trains a plurality of entity recognition models, wherein each of the plurality of entity recognition models is trained based on a respective one of the plurality of entity type groups and a respective one of the plurality of data subsets; and
generates a combined entity recognition model based on the plurality of entity recognition models.

9. The system of claim 8, wherein the processor further determines correlations between at least some of the plurality of entity types based on the data set.

10. The system of claim 9, wherein the dividing of the plurality of entity types into the plurality of entity type groups is based on calculated scores associated with said determined correlations.

11. The system of claim 9, wherein the dividing of the plurality of entity types into the plurality of entity type groups is based on a graph partitioning algorithm applied to a graph composed based on said determined correlations.

12. The system of claim 8, wherein the combined entity recognition model is generated based on only selected ones of the plurality of entity recognition models.

13. The system of claim 12, wherein each of the plurality of entity types is covered by only one of the selected ones of the plurality of entity recognition models.

14. The system of claim 8, wherein the plurality of entity references in the data set are tagged with entity types.

15. A computer program product for generating an entity recognition model, by a processor, the computer program product embodied on a non-transitory computer-readable storage medium having computer-readable program code portions stored therein, the computer-readable program code portions comprising:
an executable portion that receives a data set and a plurality of entity types, wherein the data set includes a plurality of entity references;
an executable portion that divides the plurality of entity types into a plurality of entity type groups;
an executable portion that divides the data set into a plurality of data subsets, wherein each of the plurality of data subsets is associated with a respective one of the plurality of entity type groups;
an executable portion that trains a plurality of entity recognition models, wherein each of the plurality of entity recognition models is trained based on a respective one of the plurality of entity type groups and a respective one of the plurality of data subsets; and
an executable portion that generates a combined entity recognition model based on the plurality of entity recognition models.

16. The computer program product of claim 15, wherein the computer-readable programs code portions further include an executable portion that determines correlations between at least some of the plurality of entity types based on the data set.

17. The computer program product of claim 16, wherein the dividing of the plurality of entity types into the plurality of entity type groups is based on calculated scores associated with said determined correlations.

18. The computer program product of claim 16, wherein the dividing of the plurality of entity types into the plurality of entity type groups is based on a graph partitioning algorithm applied to a graph composed based on said determined correlations.

19. The computer program product of claim 15, wherein the combined entity recognition model is generated based on only selected ones of the plurality of entity recognition models.

20. The computer program product of claim 19, wherein each of the plurality of entity types is covered by only one of the selected ones of the plurality of entity recognition models.

21. The computer program product of claim 15, wherein the plurality of entity references in the data set are tagged with entity types.
